(19) United States
(12) Patent Application Publication
(10) Pub. No.: US 2013/0276286 A1
(43) Pub. Date: Oct. 24, 2013

(54) VEHICLE OPENING COVERINGS

(71) Applicant: PRO-TECH-IT, LLC, St. Paul, MN (US)

(72) Inventor: MICHAEL LATUFF, Roseville, MN (US)

(73) Assignee: PRO-TECH-IT, LLC, St. Paul, MN (US)

(21) Appl. No.: 13/826,317

(22) Filed: Mar. 14, 2013

Related U.S. Application Data
(60) Provisional application No. 61/635,837, filed on Apr. 19, 2012.

(51) Int. Cl. B60J 11/06

(52) U.S. Cl. CPC B60J 11/06
USPC 29/428; 150/166

(57) ABSTRACT

Vehicle coverings can be used to temporarily cover one or more openings of a vehicle so as to prevent undesired materials from entering the vehicle. The coverings can include magnets, which can automatically couple the covering with the vehicle in a releasable fashion. Some coverings include suction cups to secure portions of the coverings to nonmagnetic portions of the vehicle.

### CROSS-REFERENCE TO RELATED APPLICATIONS

This application claims the benefit under 35 U.S.C. §119(e) of U.S. Provisional Patent Application No. 61/635,837, titled VEHICLE OPENING COVERINGS, which was filed on Apr. 19, 2012, the entire contents of which are hereby incorporated by reference herein.

### BACKGROUND

In some settings, such as auto body shops, it can be desirable to cover one or more openings of a vehicle. The openings may be temporary in nature, such as the opening that may exist when a window, door, or other structure has been removed so as to be replaced. Plastic films are often used as a temporary covering for such openings. The plastic films are pressed against and cling to surfaces of the vehicle that encompass and/or are adjacent to the openings. Disclosed herein are various embodiments of vehicle coverings that can differ from known covering devices (such as, for example, the plastic films) in significant and advantageous ways.

### BRIEF DESCRIPTION OF THE DRAWINGS

The written disclosure herein describes illustrative embodiments that are non-limiting and non-exhaustive. Reference is made to certain of such illustrative embodiments that are depicted in the figures, in which:

FIG. 1 is a plan view of an embodiment of a vehicle covering in accordance with an embodiment of the present disclosure;

FIG. 2 is a side elevation view of a vehicle that has temporary openings due to the removal of doors and a fender in accordance with an embodiment of the present disclosure;

FIG. 3 is a side elevation view of the vehicle of FIG. 2 with two of the vehicle coverings of FIG. 1 attached thereto;

FIG. 4 is a partial front perspective view of the vehicle and one of the vehicle coverings of FIG. 3;

FIG. 5 is a plan view of another embodiment of a vehicle covering in accordance with an embodiment of the present disclosure;

FIG. 6 is a partial front perspective view of the vehicle of FIG. 2 with the vehicle covering of FIG. 5 attached thereto;

FIG. 7 is a plan view of another embodiment of a vehicle covering in accordance with an embodiment of the present disclosure;

FIG. 8 is a plan view of a further embodiment of a vehicle covering in accordance with an embodiment of the present disclosure;

FIG. 9 is a cross-sectional view of a portion of the vehicle covering of FIG. 8 taken along the view line 9-9 in FIG. 8;

FIG. 10 is a cross-sectional view of another portion of the vehicle covering of FIG. 8 taken along the view line 10-10 in FIG. 8;

FIG. 11 is a side elevation view of the vehicle of FIG. 2 with the vehicle covering of FIG. 8 attached thereto;

FIG. 12 is a plan view of another embodiment of a vehicle covering in accordance with an embodiment of the present disclosure; and

FIG. 13 is an enlarged multiple cutaway view of the vehicle covering of FIG. 12 showing a portion of the vehicle covering that is taken from the region demarcated by the view line 13 in FIG. 12.

### DETAILED DESCRIPTION

In many instances, it can be desirable to cover one or more openings of a vehicle, and in further instances, it may be desirable to do so in a temporary fashion. The opening may be due to removal of a portion of a vehicle for repair or replacement, such as removal of a window which creates a window opening, or removal of a fender, door panel, bumper, grill, or other structure which creates a non-window opening. As a result, the vehicle may have an opening (e.g., into the cabin or internal structure of the vehicle) through which dust, debris, precipitation, or other undesirable foreign objects may be introduced, depending on whether the vehicle is indoors (e.g., in an auto body shop or garage) or outdoors. The opening may be present only temporarily. For example, it may be desirable to cover the opening for a matter of hours, or even days or weeks, while the removed parts are being repaired or while replacement parts are being shipped.

Some products that are currently used to temporarily cover such openings in a vehicle can have a number of disadvantages. For example, in some instances, a plastic film (e.g., “crash wrap”) may be used to cover and/or form a weatherproofing seal about a vehicle opening. In further instances, multiple layers of the plastic film may be used in order to cover a single opening. The film is generally configured for only a single-use and is disposable, and thus can be expensive to use and environmentally unfriendly. Using the film also can be inconvenient. For example, in many instances, it is difficult for a single person to install the film, and for some installations, two or more people may be required. Moreover, once the film is installed it can make an interior of a vehicle inaccessible, as the film would need to be removed in order to enter the vehicle and then replaced thereafter.

Certain embodiments of vehicle coverings disclosed herein avoid, ameliorate, or solve one or more of the issues discussed above and/or other issues. However, some embodiments may include one or more of the features discussed above (such as multi-person installation, etc.). Other or further advantages of embodiments of vehicle coverings will be apparent from the discussion that follows. The term “vehicle” is used broadly herein and can include, for example, cars, truck tractors and trailers, vans, boats, recreational vehicles, snowmobiles, buses, trains, airplanes, and the like. The term “covering” is also used broadly herein and can include covers, wrappings, etc.

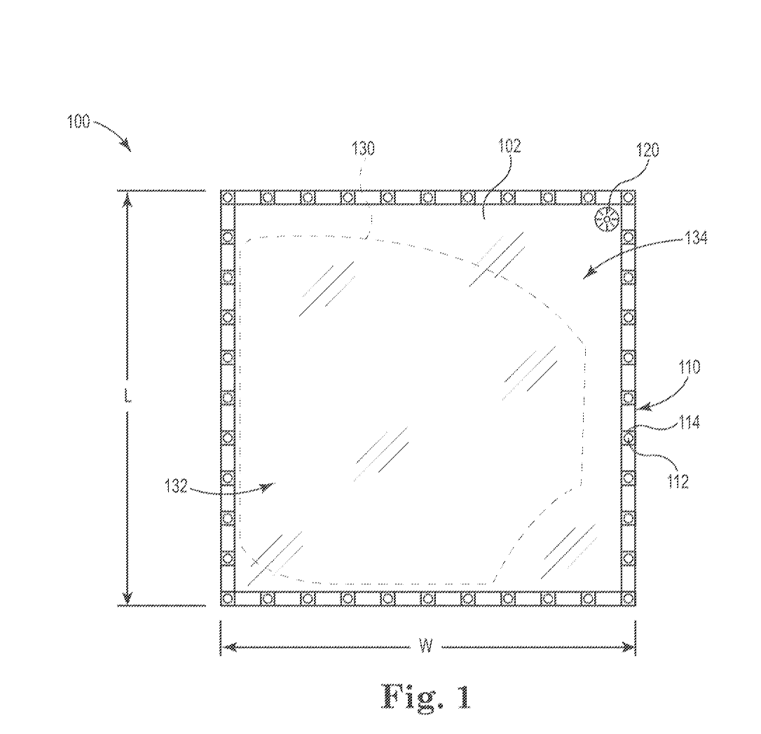

FIG. 1 is a plan view of an embodiment of a sheet or covering 100 that can be used to cover an opening of a vehicle. The covering includes a barrier member 102 and a mounting assembly 110 that is used to affix the barrier member 102 to a vehicle. The mounting assembly 110 may also be referred to as a securing member or as an attachment mechanism. The barrier member 102 can comprise any suitable material, and may have any desirable properties. For example, in various embodiments, it may be desirable for the barrier member 102 to be waterproof, transparent, flexible, and/or puncture resistant. For certain of such embodiments, the barrier member 102 can include a sheet of plastic material, such as, for example, vinyl (e.g., 6-20 gauge, 100% virgin vinyl) or other suitable plastics and/or composite sheets. In various embodiments, a thickness of the barrier member 102 can contribute to further desired properties for the covering 100, such as a particular weight and durability. In various embodiments, a thickness of a plastic (e.g. vinyl) barrier member 102 can be from about 6 gauge to about 20 gauge.

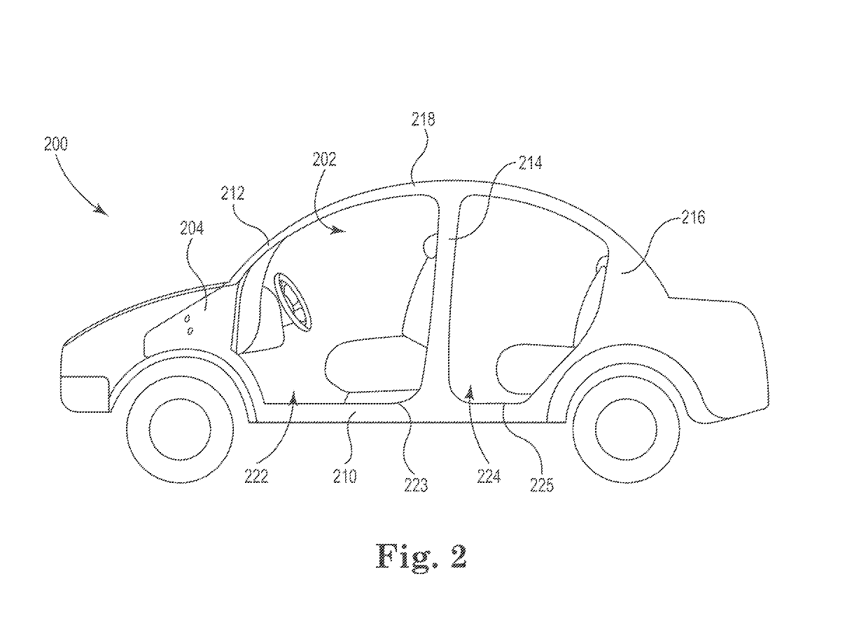

The mounting assembly 110 can be configured to couple the barrier member 102 with a vehicle, such as the vehicle 200 shown in FIG. 2. In the illustrated embodiment, the mounting assembly 110 is positioned at an outermost or peripheral edge of the barrier member 102 and extends about a full perimeter of the barrier member 102.

In the illustrated embodiment, the mounting assembly 110 includes a plurality of magnets 112. The magnets 112 are attached to the covering 100 using a variety of techniques, including adhesives, stitching, or being located in a pocket or pouch 114. The magnets 112 may be sufficiently strong to automatically secure the covering 100 to the vehicle and thereafter retain the covering 100 (or at least a portion thereof, such as the perimeter of the covering 100) in fixed relation to the vehicle, but not so strong as to prevent adjustment of the covering 100 after it has been secured to the vehicle or to prevent removal of the covering 100 when desired.

In various embodiments, each magnet 112 may have rounded edges and/or a relatively large surface area, which can aid in preventing dinging of vehicle surfaces when the magnets 112 urge the covering 100 into contact with the vehicle. For example, as discussed further below, the magnets 112 can assist in automatically coupling parts of the covering 100 with the vehicle. The strength of the magnets and/or their shape (e.g., rounded edges) can prevent the magnets 112 from applying sufficient pressure to the vehicle surface to mar or ding it during automatic coupling. Any suitable magnet composition and/or arrangement is possible. For example, in some embodiments, the magnets 112 may be neodymium magnets and may be shaped as discs. The discs may be 3/16 inches thick and have a diameter of ½ inch. Other suitable magnetic materials, shapes, and sizes are contemplated.

In some embodiments, one or more pads (not shown) or other cushioning members may be included in the pouches 114 so as to further prevent the magnets 112 from dinging or marring the vehicle surfaces. In some embodiments, a thickness and/or elastic resilience of the material used in the mounting assembly 110 may prevent dinging or marring.

In some embodiments, the mounting assembly 110 may be formed by doubling back the outermost edges of a sheet of material, such that the barrier member 102 and the mounting assembly 110 are formed from a unitary sheet of material. One or more seams may be formed so as to retain the outer portion of the material in the doubled-back configuration. Additional seems may be formed to create the pouches 114 in which the magnets 112 are retained. Any suitable method may be used to form the seams, such as adhesives, ultrasonic welding, etc. The magnets 112 may be retained within the pouches 114 formed by the doubled-back portion. In other or further embodiments, the magnets 112 may be secured to the material in any suitable manner (such as via an adhesive). In some embodiments, the magnets 112 are not retained within pouches 114. In still other or further embodiments, one or more magnets 112 may be continuous about a portion or an entirety of the perimeter of the covering 100, rather than (or in addition to) the use of multiple small magnets that are spaced apart from each other.

The covering 100 can define any suitable shape, such as square, rectangular, trapezoidal, etc. In the illustrated embodiment, the covering 100 is square, such that a length L and a width W thereof are the same. In various embodiments, one or more of the length L and the width W can be within a range of from about 2 feet to about 10 feet. In some embodiments, both the length L and the width W are no larger than a height and arm span, respectively, of a user. The user may be readily able to manipulate the covering 100 without assistance in such arrangements. For example, in various embodiments, the length L is no greater than about 4, 4.5, 5, 5.5, 6, 6.5, or 7 feet, and the width W is no greater than about 4, 4.5, 5, 5.5, 6, 6.5, or 7 feet.

In the illustrated embodiment, the magnets 112 are spaced from each other in regular intervals. Any suitable spacing may be selected. In some embodiments, the spacing may depend on such factors as ease of use and/or sufficient proximity of adjacent magnets to form seals. For example, in some instances, it may be desirable to provide relatively generous spacing between adjacent magnets. When the covering 100 is secured to the vehicle, this spacing can permit the portion of the mounting assembly 110 that is between adjacent magnets 112 to yield to a user's fingers. For example, a user may be able to readily insert fingers between the mounting assembly 110 and the vehicle surface to which the covering 100 is secured so as to grip and pull the covering 100 for removal. In other or further embodiments, the magnets 112 may be sufficiently close to each other to provide sufficient tension in the mounting assembly 110 to form a seal between the mounting assembly 110 and the vehicle surface. The seal may be liquid-tight, in some embodiments, which can prevent rain or other precipitation from entering the vehicle. In some embodiments, the mounting assembly 110 may comprise a material that readily clings to a car surface, such as to a clear coat or a glass surface, which can aid in formation of the liquid-tight seal. In various embodiments, spacing between adjacent magnets 112 can be within a range of from about 4 inches to about 8 inches. In some embodiments, the spacing is about 6 inches.

In the illustrated embodiment, the covering 100 includes a suction cup 120. The suction cup 120 can be used on portions of the vehicle that are not magnetic, such as a windshield or rear window. More suction cups 120 than just one may be used in other embodiments. For example, in some embodiments, two or more, three or more, or each corner of the covering 100 includes a separate suction cup 120. In the illustrated embodiment, the suction cup 120 is spaced from the mounting assembly 110. For example, in some embodiments, the suction cup 120 is spaced sufficiently far from the nearest magnets 112 such that when the corner of the covering 100 that includes the suction cup 120 is secured to a magnetic surface, rather than a non-magnetic surface, the suction cup 120 does not hinder attachment of the magnets 112 to the magnetic surface. For example, in some instances, the suction cup 120 may have a relatively large depth such that if the magnets 112 are too close to the suction cup 120, the depth of the suction cup 120 could hinder or prevent the magnets 112 from coming into contact with the surface against which the suction cup 120 is placed.

Any suitable suction cup arrangement is possible. For example, the suction cups may be of any suitable size and/or may be attached to the covering 100 in any suitable manner. In various embodiments, the suction cup 120 can have a diameter of about 1⅞ or 1⅛ inches and can be secured to the covering 100 via a friction ring (not shown) or any other suitable fastener or attachment mechanism. In other or further embodiments, the covering 100 may include other mechanisms for temporarily securing the covering 100 to a non-magnetic surface of a vehicle. For example, in some embodiments, a temporary adhesive may be used instead of, or in addition to, one or more suction cups 120.

In FIG. 1, the suction cup 120 is illustrated extending out of the page. That is, the face of the covering 100 that is positioned adjacent to the vehicle is illustrated.

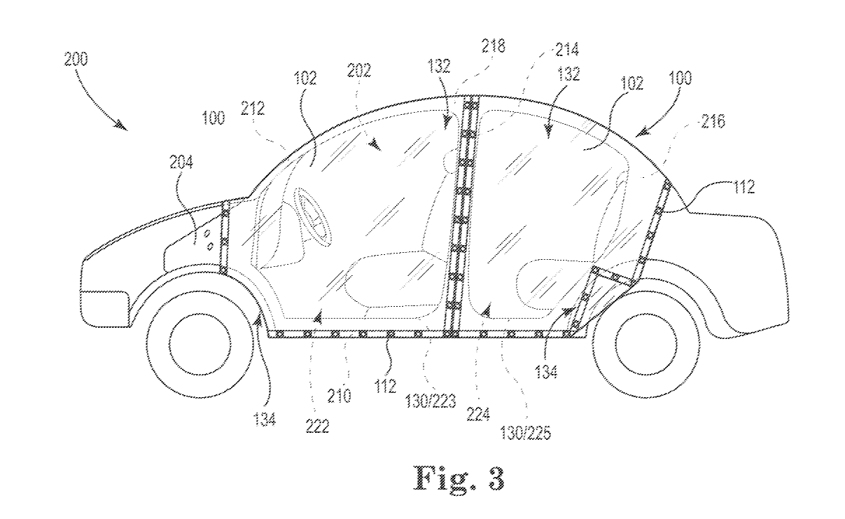

FIG. 1 includes a broken-line depiction of a vehicle opening configuration 130 that the covering 100 is configured to cover. Thus, relative to this particular opening configuration 130, the covering 100 includes a cover portion 132 and an attachment flange 134. The cover portion 132 is fully circumscribed by the attachment flange 134. The attachment flange 134 includes an entirety of the mounting assembly 110. As can be appreciated from FIG. 1 and the discussion of FIG. 3 below, the illustrated covering 100 can be well-suited and adaptable or reconfigurable for use with a variety of opening configurations 130 of different shapes.

FIG. 2 depicts a side elevation view of an embodiment of a vehicle 200, specifically a car, with which the covering 100 of FIG. 1 may be used. Moreover, the covering 100 may be resized and reshaped as desired for any desired vehicle configuration.

The illustrated vehicle 200 is a car from which the driver-side fender and doors have been removed. The removed portions of the vehicle 200 thus expose an interior or cabin 202 of the vehicle 200, as well as a metallic piece 204. Portions of the vehicle 200 that are exposed include a base 210, a roof 218, and a driver-side A column 212, B column 214, and C column 216. The base 210 and the columns 212, 214, 216 may also be referred to as frame portions of the vehicle 200. The A column 212, the roof 218, the B column 214, the base 210, and the metallic piece 204 may each comprise metallic materials and may cooperate to define a front non-window opening 222 that defines a first perimeter 223.

This first perimeter 223 is the mirror image of the opening configuration 130 depicted in FIG. 1. The B column 214, the roof 218, the C column 216, and the base 210 cooperate to define a rear non-window opening 224 that defines a second perimeter 225. The first and second perimeters 223, 225 of the front and rear non-window openings 222, 224, respectively, are different from each other. As can be appreciated from the foregoing description and drawings, the openings 222, 224 can be sized to permit entrance or exit of a passenger to or from the cabin of the vehicle 200 thereat. The illustrated openings 222, 224 are bordered by metallic components of the vehicle.

FIG. 3 depicts two separate coverings 100 that are coupled with the vehicle 200. The coverings 100 are identical to each other when they are not coupled with the vehicle 200. The coverings 100 are capable of being oriented so as to fully cover or span the front and rear openings 222, 224, respectively, which have the differently shaped perimeters 223, 225.

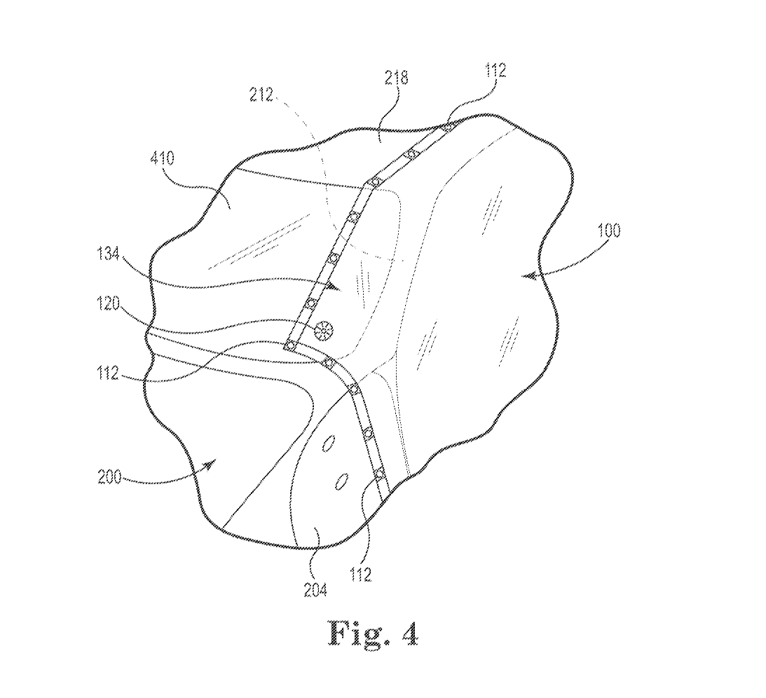

With reference to FIGS. 3 and 4, the magnets 112 and the suction cup 120 secure the front covering 100 to the vehicle 200 so as to cover the opening 222 and provide a barrier between an external environment and the cabin 202. The magnets 112 are attached to the roof 218, the B column 214, the base 210, and the metallic piece 204.

As shown in FIG. 4, an upper corner portion of the attachment flange 134 of the front covering 100 extends around the A column and over a portion of a windshield 410 of the vehicle 200. The suction cup 120 has been depressed so as to secure this portion of the attachment flange 134 to the vehicle 200, as the neighboring magnets 112 do not magnetically interact with the windshield 410.

With reference to FIG. 3, a lower corner portion of the attachment flange 134 of the front covering 100 has been folded up under the wheel well (and thus out of view). Magnets 112 (not visible in this view) secure this portion of the attachment flange 134 to the wheel well. Such an arrangement allows that vehicle 200 to be moved, if desired, with the covering 100 attached to it, as discussed further below.

In some methods for installing the front covering 100, the covering is extended or expanded outwardly so as to be substantially planar. For example, a user can grasp the two upper corners of the covering 100 and pull them apart from each other so as to fully extend the upper end of the covering 100. The weight of the remaining portion of the covering 100 (and in some instances, particularly the weight of the lower edge of the mounting assembly 110 with its row of magnets 112) can pull the covering 100 into a substantially planar configuration. Thereafter, the user can move the covering 100 toward the vehicle 200 with the planar covering 100 substantially parallel to the perimeter of the front opening 222.

As the covering 100 is approximated sufficiently close to the opening 222, the magnets 112 automatically attach to the B column 214, the base 210, and the metallic piece 204. The user can then wrap an upper end of the covering 100 over the roof 118 and allow the upper magnets 118 to be secured to the roof 118. The upper forward corner of the attachment flange 134 can be secured to the windshield 410 and the lower forward corner of the attachment flange 134 can be secured to an inner portion of the wheel well in the manners discussed above.

Tension can be applied to various portions of the covering 100 so as to pull it tight and, in some instances, provide a weatherproofing seal about the opening 222. In some methods, it may be desirable to lift a magnet 112 free of the vehicle 200 and move it away from an adjacent magnet 112 that is coupled to the vehicle 200 to render taut the portion of the mounting assembly 110 that is between the set of adjacent magnets. This process can be repeated with an additional magnet that is adjacent to the magnet that was just repositioned. In this manner, a user may continue sequentially about a perimeter of the covering 100 to readjust the magnets and tighten the covering. Such an approach, in which the magnets 112 are lifted away from the vehicle body, may avoid scratching of the vehicle 200 that might otherwise result from sliding the magnetic regions. However, in other installation techniques, a user may merely grip a portion of the covering 100 and pull to tighten the covering 100 so that it lays flat relative to the vehicle 200.

In such installation techniques, the magnetic portions of the mounting assembly 110 may be permitted to slide along various surfaces of the vehicle 200. In some instances, the mounting assembly 110 may be configured to slide over vehicle surfaces without scratching or marring surfaces of the vehicle. In certain of such instances, it may be desirable to clean the mounting assembly 110, particularly in the region of the magnets 112, prior to use of the covering 100 and/or between uses of the covering 100. The order of the various stages of the attachment sequence just discussed can be altered or rearranged in any suitable manner. Other variations of installation methods are also contemplated.

In some instances, it may be desirable to move the vehicle 200 after the front covering 100 has been placed over the opening 222. Some methods of using the covering 100 can include accessing the driver seat of the vehicle 200 while the covering 100 is still secured to the vehicle 200. For example, in some instances, the bottom rear corner of the covering 100 can be pulled away from the B column 214 and the base 210 and draped over the windshield 410 to permit a user to enter the vehicle 200 via the opening 222. After moving the vehicle 200, the user can exit the vehicle 200 via the opening 222 and reattach the magnets 112 of the bottom rear corner of the covering 100 to the B column 214 and the base 210.

With further reference to FIG. 3, the rear covering 100 can be secured over the rear opening 224 in a manner similar to that discussed above with respect to the front covering 100. The magnets 112 of the rear covering 100 are secured to the B column 214, the roof 218, the C column 216, and the base 210. Although not shown in this view, an upper rear corner of the attachment flange 134 is secured to a rear window of the vehicle 200 in a manner such as that discussed above with respect to FIG. 4. A lower rear corner of the attachment flange 134 is moved clear of the rear wheel. Rather than curling this corner back into the wheel well in a manner similar to that discussed with respect to the front wheel well, another option is to fold the corner upwardly and forwardly over a portion of the barrier member 102. The magnets 112 interact with a rear metallic panel to sandwich this portion of the barrier member 102 between them and the panel.

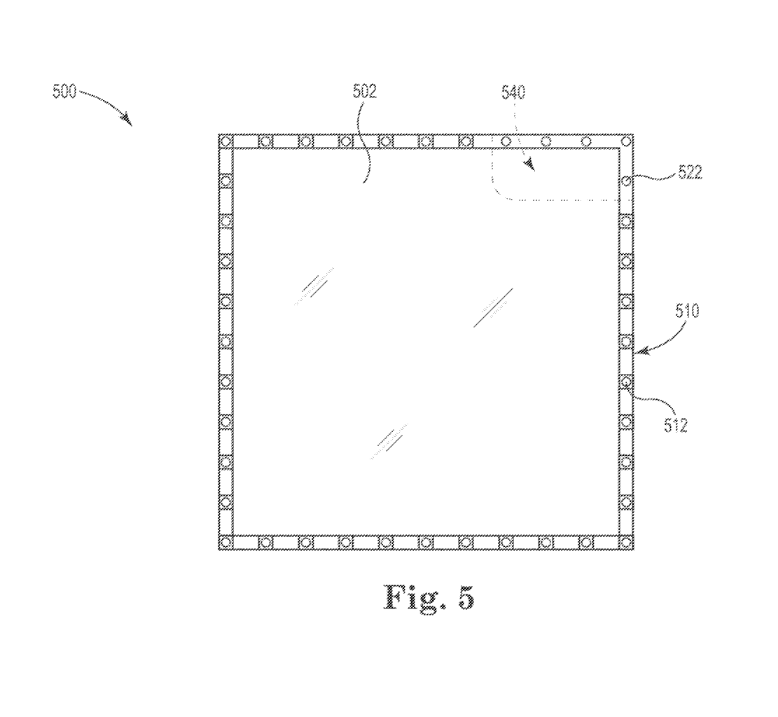

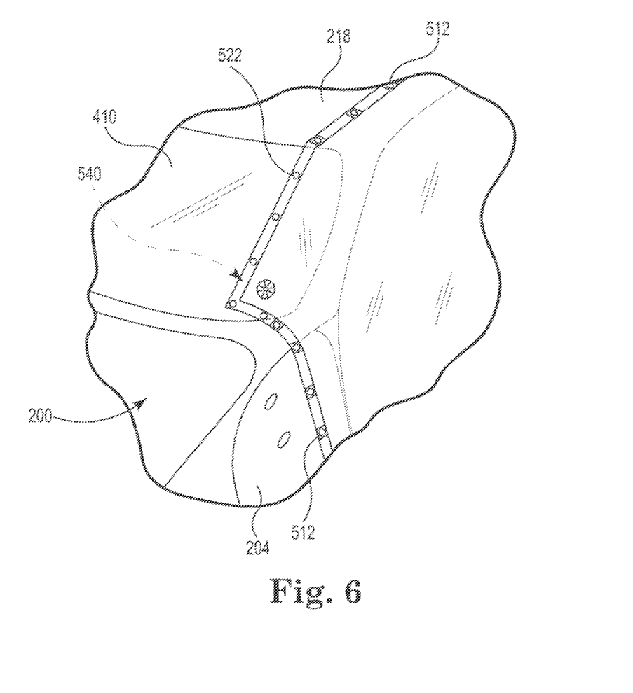

FIGS. 5 and 6 illustrate another embodiment of a covering 500 that can resemble the covering 100 described above in certain respects. Accordingly, like features are designated with like reference numerals, with the leading digits incremented to “5.” Relevant disclosure set forth above regarding similarly identified features thus may not be repeated hereafter. Moreover, specific features of the covering 500 may not be shown or identified by a reference numeral in the drawings or specifically discussed in the written description that follows. However, such features may clearly be the same, or substantially the same, as features depicted in other embodiments and/or described with respect to such embodiments. Accordingly, the relevant descriptions of such features apply equally to the features of the covering 500. Any suitable combination of the features and variations of the same described with respect to the covering 100 can be employed with the covering 500, and vice versa. This pattern of disclosure applies equally to further embodiments depicted in subsequent figures and described hereafter, wherein the leading digits may be further incremented.

The covering 500 includes a barrier member 502 such as the barrier member 102 discussed above. The covering 500 further includes a mounting assembly 510 similar to the mounting assembly 110 discussed above. However, a predetermined region 540 of the covering 500 is configured to be positioned over the windshield 410. In this region 540, the mounting assembly 510 includes multiple suction cups 522, rather than magnets. Any suitable number and/or arrangement of suction cups 522 is possible. Such an arrangement can, in some instances, provide a more significant connection between the covering 500 and the vehicle 200 in this region. Magnets 512 can be used in other regions of the covering 500 in manners such as described above.

In other embodiments, the region 540 may be devoid of suction cups. For example, in some embodiments, the material of which the region 540 is formed may be able to self-adhere to glass. Other suitable attachment techniques are also contemplated.

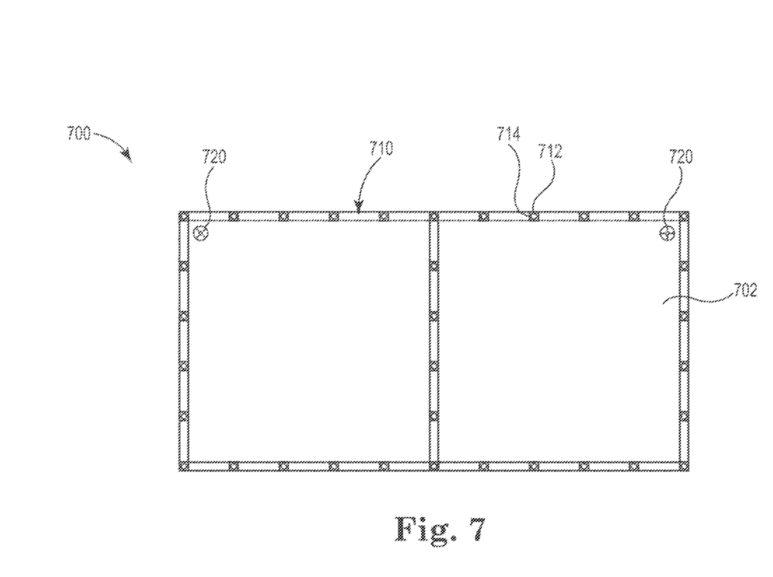

FIG. 7 illustrates another embodiment of a covering 700. This embodiment is similar to the two coverings 100 shown in FIG. 3. In this embodiment, the covering 700 is configured to cover both the front and rear openings 222, 224 of the vehicle 200 (see FIG. 2). Such an arrangement may reduce costs, in some instances, as fewer magnets might be used for connecting the covering 700 to the B pillar 214.

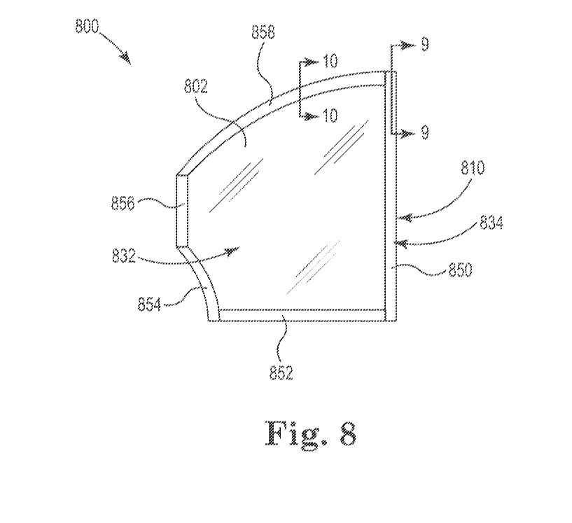

FIG. 8 illustrates another embodiment of a covering 800. This embodiment is similar to the covering 100 shown in FIG. 1. The external face of the covering 800 is shown in FIG. 8, whereas the internal face of the covering 100 is shown in FIG. 1. The covering 800 includes a barrier member 802, a mounting assembly 810, a cover portion 832, and an attachment flange 834 that resemble similarly identified features of the cover 100. However, the attachment flange 834 is significantly smaller than the attachment flange 134. Additionally, the attachment flange 834 is tailored for use with only the front opening 222. The covering 800 also is devoid of suction cups, and is generally configured to be secured to the vehicle 200 primarily via magnetic interaction.

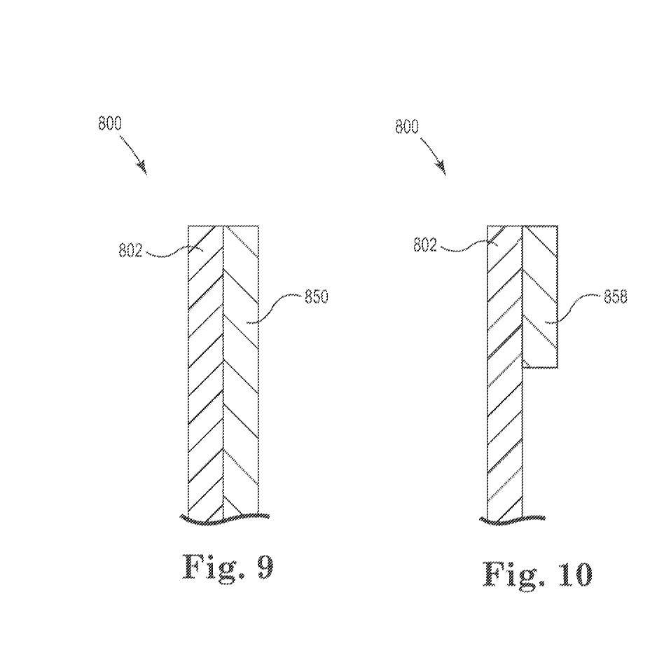

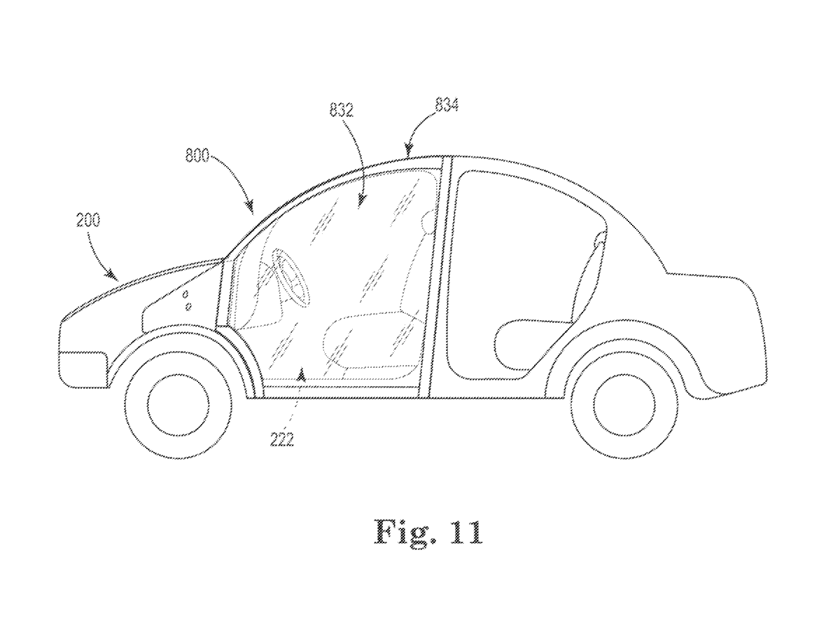

In the illustrated embodiment, the mounting assembly 810 includes five magnetic strips 850, 852, 854, 856, 858 that abut one another. In other embodiments, a single and/or continuous magnetic strip may be used. As shown in FIGS. 9 and 10, unlike the magnets 112 discussed above, the magnetic strips 850, 852, 854, 856, 858 are not positioned within pouches, but are instead attached to an external surface of a sheet of material that forms the barrier member 802 with an adhesive, stitching, or the like. FIG. 11 illustrates the covering 800 coupled with the vehicle 200 so as to cover the opening 222. In various other embodiments, the shape and configuration of the covering 800 can be arranged to fit over any desired opening.

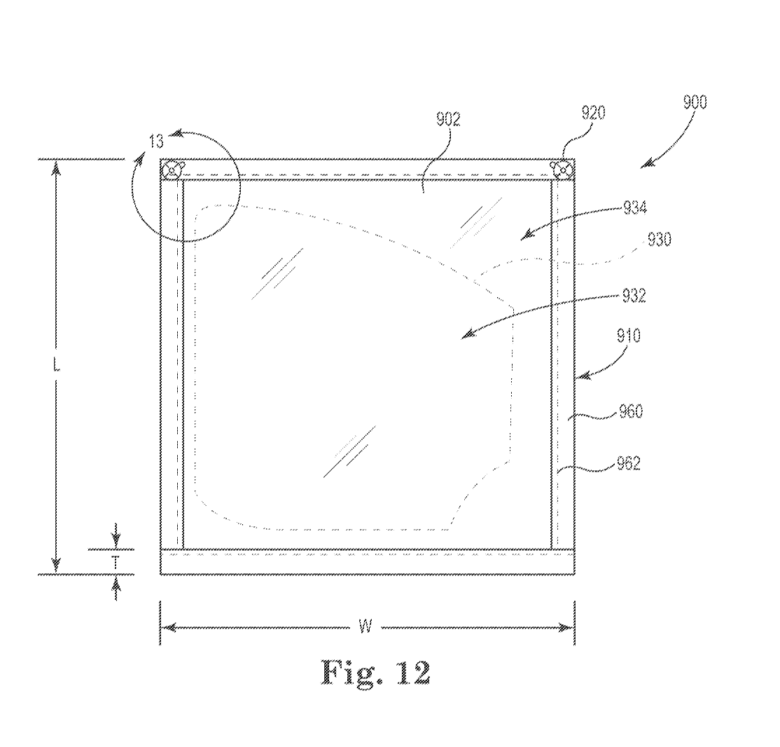

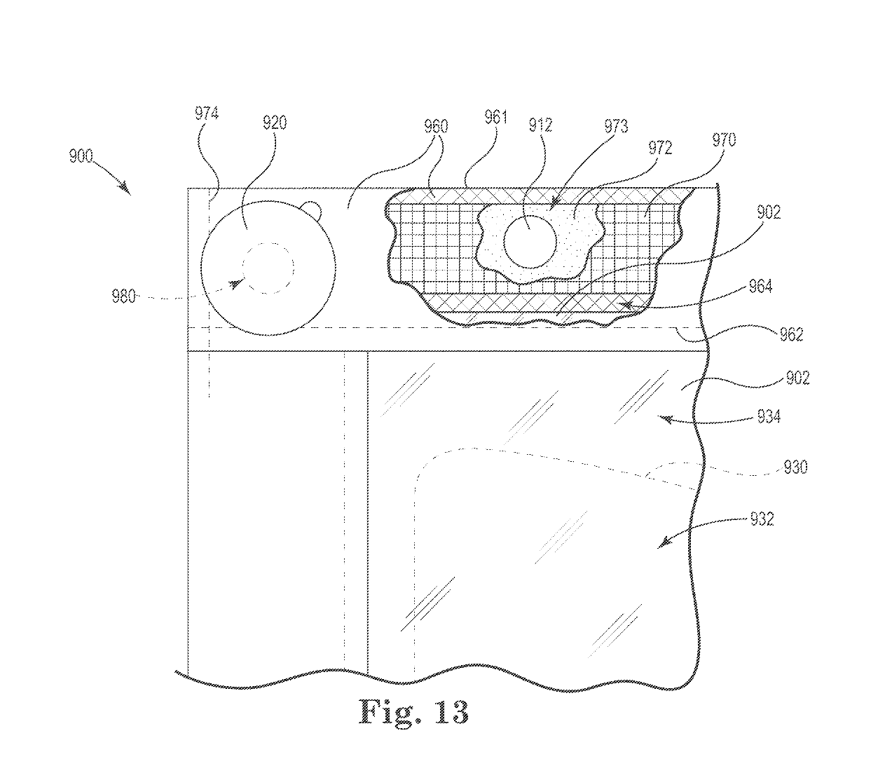

FIGS. 12 and 13 illustrate another embodiment of a covering 900 that includes a barrier member 902 and a mounting assembly 910. The mounting assembly 910 is attached to each edge of the barrier member 902 so as to extend about a full periphery of the barrier member 902. In the illustrated embodiment, the mounting assembly 910 includes four border panels 960 that are secured to the respective four ends of the barrier member 902 via stitching 962. Any suitable ratio of the thickness T (i.e., the distance from the exterior edge to the interior edge) of each border panel 960 to the width W and/or length L of the covering 900, when viewed in a plan view (as shown in FIG. 12) or elevation view, is possible. In some embodiments, the width W and/or the length L are no more than about 4, 5, or 6 feet, and the portion of each border panel 960 illustrated in FIG. 12 can have a thickness of no more than about 1.5, 1.75, 2.0, 2.25, or 2.5 inches.

The covering 900 can be used in any suitable manner, such as those discussed above with respect to FIG. 3, for example. As with the covering 100 discussed above, the covering 900 can be configured to be cover vehicle openings of a variety of different profiles. One such profile 930 is illustrated, which corresponds to the perimeter 223 of the vehicle 200 shown in FIG. 2. Any other suitable shape of the profile 930 is possible, and can desirably be smaller than the portion of the barrier member 902 that is not covered by the border panels 960.

In the illustrated embodiment, the covering 900 can include a cover portion 932 and an attachment flange 934, as discussed above. The attachment flange 934 includes an outer flap of the barrier member 902 that extends outwardly beyond the profile 930 and further includes the mounting assembly 910. In the illustrated embodiment, two of the four corners of the covering 900 each include a separate suction cup 920.

With reference to FIG. 12, each border panel 960 can be folded along an outer edge 961 and doubled back. The inner edges of the border panel 960 can be stitched together via the stitching 962 to thereby form an extended pocket 964. In the illustrated embodiment, the pocket 964 extends along substantially a full longitudinal length of the border panel 960. In further embodiments, the pocket 964 can extend along at least a majority of a longitudinal length of the border panel 960. An edge of the barrier member 102 can be captured between the inner edges of the border panel 960 and stitched thereto via the stitching 962.

The border panel 960 can be formed of any suitable material. In some embodiments, the border panel 960 may desirably be flexible to permit the border panel 960 to closely conform to various contours of various vehicles. The border panel 960 may also be desirably flexible to permit the entire covering 900 to be foldable. For example, in some embodiments, the covering 900 may be folded multiple times into a compact form for packaging, storage between uses, etc. The border panel 960 may also be durable. A thickness of the material of which the border panel 960 is formed (e.g., a thickness transverse to the dimension T shown in FIG. 12) and/or other properties thereof can permit the border panel 960 to soften initial impact from one or more magnets 912 as the magnets 912 magnetically couple with the vehicle.

Any suitable number of magnets 912 is possible, as discussed above with respect to the magnets 112. In the illustrated embodiment, the edge-most magnet 112 shown in FIG. 13 is spaced from the corner of the covering 930. In other or further embodiments, the edge-most magnet 112 may be positioned at the corner.

The magnets 112 may be secured to the border panels 960 in any suitable manner. In the illustrated embodiment, each magnet 912 is enveloped in a piece of tape 970. Stated otherwise, the adhesive side 972 of the tape 970 may be adhered to itself about an entirety of each magnet 912 so as to entrap the magnet 912 in a pocket 973. Such an arrangement can leave only the non-sticky side of the tape 970 exposed, which may facilitate manufacture of the covering 900. The tape 970 may extend along the longitudinal length of the border panel 960, and may be attached to the edge thereof via stitching 974. Accordingly, in some embodiments, attachment of the magnets 912 to the tape 970 may occur in one manufacturing step. A length of the magnet-laden tape 970 may be secured to the border panel 960 at an interior of the pocket 964 in a subsequent manufacturing step.

Other assembly arrangements and methods are also possible. For example, in some embodiments, the magnets 912 may merely be adhered to an inner face of a border panel 960 by pressing the adhesive side 972 of the tape 970 into contact with the inner face of the border panel 960 about at least a portion of a perimeter of each magnet 912. Stated otherwise, in some embodiments, the adhesive side 972 of the tape 970 may face and directly contact an inner surface of the border panel 960. The tape 970 may be of any suitable variety and may be flexible. In some embodiments, the tape 970 comprises duct tape, or cloth- or scrim-backed pressure-sensitive tape, which may be coated with plastic (e.g., polyethylene).

With continued reference to FIG. 13, each suction cup 920 can be mounted to the covering 900 in any suitable manner. In the illustrated embodiment, a fastener 980 is inserted through multiple layers of one or more border panels 960 and joined to the suction cup 920 in any suitable manner (e.g., friction fit, adhesive, welding).

As discussed above, and as can also be appreciated from the foregoing disclosure, various methods of using various coverings disclosed herein are possible. For example, in some methods, a covering 100, 300, 500, 700, 800, 900 is secured to a vehicle 200 over an opening 222, 224 of the vehicle. The covering can comprise a barrier member 102, 302, 502, 702, 802, 902 and a mounting assembly 110, 310, 510, 710, 810, 910. The mounting assembly can comprise a plurality of magnets 112, 312, 512, 712, 850, 852, 854, 856, 858, 912 that extend about at least a portion of the barrier member. Securing the covering to the vehicle comprises magnetically coupling the mounting assembly to the vehicle such that the barrier member spans the opening (e.g., see FIGS. 3 and 11).

Some methods can include providing the vehicle with the opening, such as by removing one or more of a door, a window, or a body panel from the vehicle. Accordingly, the opening 222, 224, may expose an interior region of the vehicle to an environment that is external to the vehicle. As can be appreciated, the openings 222, 224 may be of a type that is not present when the vehicle is fully assembled (e.g., a new car in the lot of a dealership) and is in a closed state (e.g., all windows closed).

As previously discussed, some methods of securing a covering to a vehicle comprises advancing the mounting assembly into close proximity to the vehicle and permitting the plurality of magnets to magnetically couple with a portion of the vehicle automatically. For example, in some instances, the covering may be draped in a vertical orientation and advanced horizontally toward the vehicle until the plurality of magnets automatically couple with the portion of the vehicle (e.g., the magnetic frame). In some embodiments, the mounting assembly includes a suction cup, and the covering may be secured to the vehicle by mounting the suction cup to a non-magnetic region of the vehicle (e.g., a windshield or rear window, as discussed above).

In some instances, after the covering has been used to cover an opening of the vehicle, the mounting assembly can be removed from the vehicle. In some arrangements, the covering can then be folded into a compact state in which an outermost perimeter of the covering is smaller than the outermost perimeter is when the covering is coupled to the vehicle.

Any methods disclosed herein comprise one or more steps or actions for performing the described method. The method steps and/or actions may be interchanged with one another. In other words, unless a specific order of steps or actions is required for proper operation of the embodiment, the order and/or use of specific steps and/or actions may be modified.

References to approximations are made throughout this specification, such as by use of the terms “about” or “approximately.” For each such reference, it is to be understood that, in some embodiments, the value, feature, or characteristic may be specified without approximation. For example, where qualifiers such as “about,” “substantially,” and “generally” are used, these terms include within their scope the qualified words in the absence of their qualifiers. For example, where the term “substantially planar” is recited with respect to a feature, it is understood that in further embodiments, the feature can have a precisely planar orientation.

Reference throughout this specification to “an embodiment” or “the embodiment” means that a particular feature, structure or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, figure, or description thereof for the purpose of streamlining the disclosure. This method of disclosure, however, is not to be interpreted as reflecting an intention that any claim require more features than those expressly recited in that claim. Rather, as the following claims reflect, inventive aspects lie in a combination of fewer than all features of any single foregoing disclosed embodiment.

The claims following this written disclosure are hereby expressly incorporated into the present written disclosure, with each claim standing on its own as a separate embodiment. This disclosure includes all permutations of the independent claims with their dependent claims. Recitation in the claims of the term “first” with respect to a feature or element does not necessarily imply the existence of a second or additional such feature or element. Elements specifically recited in means-plus-function format, if any, are intended to be construed in accordance with 35 U.S.C. §112(f). Embodiments of the invention in which an exclusive property or privilege is claimed are defined as follows.

1. A method of protecting a vehicle, the method comprising:
securing a covering to the vehicle over an opening of the vehicle, wherein the covering comprises:
a barrier member; and
a mounting assembly that comprises a plurality of magnets that extend about at least a portion of the barrier member,
wherein securing the covering to the vehicle comprises magnetically coupling the mounting assembly to the vehicle such that the barrier member spans the opening.

2. The method of claim 1, further comprising providing the vehicle with the opening, wherein the opening exposes an interior region of the vehicle to an environment that is external to the vehicle, and wherein the opening is not present when the vehicle is fully assembled and is in a closed state.

3. The method of claim 2, wherein providing the vehicle with the opening comprises removing one or more of a door, a window, or a body panel from the vehicle.

4. The method of claim 1, wherein the opening comprises a non-window opening.

5. The method of claim 1, wherein securing the covering to the vehicle comprises advancing the mounting assembly into close proximity to the vehicle and permitting the plurality of magnets to magnetically couple with a portion of the vehicle automatically.

6. The method of claim 5, wherein securing the covering to the vehicle further comprises draping the covering in a vertical orientation and advancing the covering horizontally toward the vehicle until the plurality of magnets automatically couple with the portion of the vehicle.

7. The method of claim 5, wherein the mounting assembly further comprises a suction cup, and wherein securing the covering to the vehicle further comprises mounting the suction cup to a non-magnetic region of the vehicle.

8. The method of claim 7, wherein the non-magnetic region of the vehicle is one of a windshield or a rear window.

9. The method of claim 1, further comprising:
uncoupling a first portion of the mounting assembly from the vehicle to provide access to a cabin of the vehicle while a second portion of the mounting assembly remains magnetically coupled to the vehicle;
entering the cabin of the vehicle through the opening; and
moving the vehicle while positioned at an interior of the cabin.

10. The method of claim 9, further comprising:
exiting the vehicle through the opening; and
re-coupling the first portion of the mounting assembly to the vehicle without uncoupling the second portion of the mounting assembly from the vehicle.

11. The method of claim 1, wherein securing the covering to the vehicle comprises magnetically coupling the mounting assembly to a frame portion of the vehicle that is not is not exposed when the vehicle is fully assembled and is in a closed state.

12. The method of claim 1, wherein the mounting assembly extends about a full periphery of the barrier member.

13. The method of claim 1, wherein the barrier member and the mounting assembly are flexible, the method further comprising:
uncoupling the mounting assembly from the vehicle; and
folding the covering into a compact state in which an outermost perimeter of the covering is smaller than the outermost perimeter is when the covering is coupled to the vehicle.

14. A method of protecting a vehicle, the method comprising:
magnetically coupling a covering to the vehicle over an opening of the vehicle is not present when the vehicle is fully assembled and is in a closed state, wherein the opening is present due to an absence of one or more of a door, a window, or a body panel from the vehicle.

15. The method of claim 14, wherein the covering comprises a plurality of magnets that extend about a periphery of a flexible barrier member.

16. The method of claim 14, wherein the covering comprises a suction cup, the method further comprising coupling a portion of the covering to a non-magnetic region of the vehicle via the suction cup.

17. The method of claim 14, wherein, after the covering has been magnetically coupled to the vehicle and has been coupled to the non-magnetic region of the vehicle via the suction cup, the covering is simultaneously in a coupled arrangement with the vehicle via interaction of a plurality of magnets with a frame of the vehicle and via interaction of the suction cup with one of a windshield or a rear window of the vehicle.

18. A covering for a vehicle, the covering comprising:
a flexible barrier element sized to span an opening of a vehicle through which a passenger can enter or exit the vehicle such that the barrier element extends outwardly beyond a perimeter of the opening; and
a mounting assembly that encompasses the barrier element, wherein the mounting assembly comprises:
a flexible border panel attached to the barrier element, wherein the border panel defines a pocket;
a magnet positioned at an interior of the pocket; and
a suction cup coupled to the border panel,
wherein the suction cup is configured to be coupled with one of a windshield and rear window of the vehicle while the magnet is coupled with a B pillar of the vehicle.

19. The covering of claim 18, wherein the mounting assembly further comprises a length of tape that is coupled to the magnet and positioned within the pocket.

20. The covering of claim 18, wherein the mounting assembly further comprises a line of stitching that secures opposing ends of the border panel to each other and that extends through the barrier element.

21. The covering of claim 18, wherein covering is configured to be folded into a folded state such that an outermost perimeter of the covering when in the folded state is smaller than the outermost perimeter when the covering is in a deployed state in which the covering is coupled to a vehicle.
